(19) United States
(12) Patent Application Publication
(10) Pub. No.: US 2012/0284491 A1
(43) Pub. Date: Nov. 8, 2012

(54) STARTUP/SHUTDOWN SEQUENCE

(75) Inventors: Scott Michael Harvey, Wake Forest, NC (US); Barton T. Meeks, Raleigh, NC (US); Prayson Will Pate, Durham, NC (US)

(73) Assignee: Overture Networks, Inc., Morrisville, NC (US)

(21) Appl. No.: 13/284,878

(22) Filed: Oct. 29, 2011

Related U.S. Application Data
(60) Provisional application No. 61/408,335, filed on Oct. 29, 2010.

(51) Int. Cl. G06F 9/24

(52) U.S. Cl. 713/1

(57) ABSTRACT

Linux, UNIX and other operating systems allow for the customization of the boot up process by adding symbolic links and scripts to certain directories in the root filesystem. Such customization is done at the time the system is created or updated via patches. The current disclosure teaches a method to simplify customization, both from the standpoint of installation as well as from the standpoint of the application developer. This abstract is provided as a tool for those searching for patents, and not as a limitation on the scope of the claims.

### RELATED APPLICATIONS

This application claims benefit under 35 USC §119(e) and incorporates by reference U.S. Provisional Application No. 61/408,335 filed Oct. 29, 2010 for STARTUP/SHUTDOWN SEQUENCE.

### BACKGROUND

1. Field of the Disclosure

This disclosure relates generally to customized startup or shutdown sequences for computers.

2. Definitions and Concepts

Arg[0]—Most operating systems pass the arguments to the called program as an array whose indexing starts at 0. The first argument is therefore “arg[0]”, “argv[0]”, “$0”, etc. depending on the specific implementation.

Root filesystem—from http://www.linfo.org/root_filesystem.html:

The root filesystem is the filesystem that is contained on the same partition on which the root directory is located, and it is the filesystem on which all the other filesystems are mounted (that is, logically attached to the system) as the system is booted up (that is, started up).

The exact contents of the root filesystem will vary according to the computer, but they will include the files that are necessary for booting the system and for bringing it up to such a state that the other filesystems can be mounted as well as tools for fixing a broken system and for recovering lost files from backups. The contents will include the root directory together with a minimal set of subdirectories and files, on some systems including /boot, /dev, /etc, /bin, /sbin and /tmp (for temporary files).

Runlevel refers to a particular mode of operation in certain computer operating systems. Runlevel defines the state of the machine after boot. For purposes of illustration, an example of a set of different runlevels is provided below.

| | Name | Description |
|---|---|---|
| 0 | Halt | Shuts down the system. |
| 1 | Single-User Mode | Mode for administrative tasks. |
| 2 | Multi-User Mode | Does not configure network |
| | | interfaces and does not |
| | | export networks services. |
| 3 | Multi-User Mode with Networking | Starts the system normally. |
| 4 | Not used/User-definable | For special purposes. |
| 5 | Start the system normally with | As runlevel 3 + display |
| | appropriate display manager. | manager. |
| | (with GUI) | |
| 6 | Reboot | Reboots the system. |

(From http://en.wikipedia.org/wiki/Runlevel).

Symbolic link (AKA soft link)—from http://en.wikipedia.org/wiki/Symbolic_link:
In computing, a symbolic link (soft link) is a special type of file that contains a reference to another file or directory.
Symbolic links operate transparently for most operations: programs that read or write to files named by a symbolic link will behave as if operating directly on the target file. However, programs that need to handle symbolic links specially (e.g., backup utilities) may identify and manipulate them directly.

/etc/init.d and /etc/rc.d—These directories control application initialization and/or shutdown during bootup and/or shutdown of a Linux system. Each runlevel may have specific directories for entering that runlevel.

Permanent changes. Within the scope of this disclosure a permanent change is a non-temporary change. Meaning a change that remains until some subsequent action works to remove this permanent change by deleting or modifying it. Permanent in this context does not mean immutable.

Initialization Directory. An operating system may be an initialization directory that in turn contains a number of sub-directories. The sub-directories may be relevant for particular runlevels or for particular changes in state. The term initialization directory should be interpreted to include any sub-directories included in the initialization-directory.

### BACKGROUND

Many computer systems, including Linux systems, have a standardized way of starting installed applications. This is accomplished by a series of symbolic links in the directories under a particular directory such as /etc/rc.d, which is part of the root filesystem. These links point to scripts that reside in other parts of the filesystem.

When the set of applications is updated, part of the installation may be updates to the links in this directory. Such updates may involve one or more of the following:
Deleting previously installed links;
Adding new links;
Modifying standard scripts such as /etc/rc.d/rc.local; and
Ensuring that the installed links map correctly to user scripts.

The problems with the above approach include:

Deletion and creation of the links is done by a multiple installation script. Developing these scripts requires the application developers to keep track of and coordinate a set of soft links in one directory and a set of scripts in another, and potentially with other installation scripts. This is a process that is prone to errors.

For example, here is a listing of /etc/rc.d/rc3.d for an exemplary embedded Linux system. When triggered, the operating system will execute each file located in this subdirectory by an alphabetized list of the file names.

K34dhcrelay -> ../init.d/dhcrelay
K50netconsole -> ../init.d/netconsole
K80usermode-agent -> ../init.d/usermode-agent
K89rdisc -> ../init.d/rdisc
S07ovn setmac -> ../init.d/ovn setmac
S10network -> ../init.d/network
S12syslog-ng -> ../init.d/syslog-ng
S13portmap -> ../init.d/portmap
S20ovn setip -> ../init.d/ovn setip
S25netfs -> ../init.d/netfs
S55sshd -> ../init.d/sshd
S56xinetd -> ../init.d/xinetd
S98dhcpd -> ../init.d/dhcpd
S99cracklibd -> ../init.d/cracklibd
S99local -> ../rc.local

The files are executed in sort order (the files are automatically alphabetized). Note that the files are named as either “Knnxxxx” or “Snnxxxx” where:

The “Knnxxx” links point to “kill” scripts that end certain programs.

The “Snnxxx” links point to “start” scripts that initialize certain programs.

Updating the above list of executable links for a specific application might include:

Adding content to a main script file such as /etc/rc.d/rc.local e.g.
/ovn/initscripts/ovn_services start

Removing previously-installed links from existing directories such as /etc/rc.d/rc3.d

Adding links to existing directories such as /etc/rc.d/rc3.d named:

S65ovn_pow_driver -> ../init.d/ovn_pow_driver
S67ovn_mdio_driver -> ../init.d/ovn_mdio_driver

Automating all of the above by creating an installation script or “patch”.

Installing the patch as a part of a software upgrade.

The teachings of the present disclosure provided in the detailed description differ from the approach set forth above and the differences have advantages over the prior art.

### SUMMARY OF THE DISCLOSURE

Aspects of the teachings contained within this disclosure are addressed in the claims submitted with this application upon filing. Rather than adding redundant restatements of the contents of the claims, these claims should be considered incorporated by reference into this summary.

This summary is meant to provide an introduction to the concepts that are disclosed within the specification without being an exhaustive list of the many teachings and variations upon those teachings that are provided in the extended discussion within this disclosure. Thus, the contents of this summary should not be used to limit the scope of the claims that follow.

Inventive concepts are illustrated in a series of examples, some examples showing more than one inventive concept. Individual inventive concepts can be implemented without implementing all details provided in a particular example. It is not necessary to provide examples of every possible combination of the inventive concepts provide below as one of skill in the art will recognize that inventive concepts illustrated in various examples can be combined together in order to address a specific application.

Other systems, methods, features and advantages of the disclosed teachings will be or will become apparent to one with skill in the art upon examination of the following figures and detailed description. It is intended that all such additional systems, methods, features and advantages be included within the scope of and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 provides a summary of one implementation of the teachings of the present disclosure.

FIG. 2 is a high level representation of a computer system.

### DETAILED DESCRIPTION

Inventive concepts are illustrated in a series of examples, some examples showing more than one inventive concept. Individual inventive concepts can be implemented without implementing all details provided in a particular example. It is not necessary to provide examples of every possible combination of the inventive concepts provided below as one of skill in the art will recognize that inventive concepts illustrated in various examples can be combined together in order to address a specific application.

Other systems, methods, features and advantages of the disclosed teachings will be or will become apparent to one with skill in the art upon examination of the following figures and detailed description. It is intended that all such additional systems, methods, features and advantages be included within the scope of and be protected by the accompanying claims.

One of the teachings of the current disclosure is installing a single permanent soft link in the initialization directory when the system is initially constructed. Thereafter, additional soft links are installed at startup time as needed. Doing so improves on the prior art in various ways including:

There is no need for development and installation of a separate patch. All needed operations are covered in the application software and scripts.

All of the needed initialization routines can be contained in a single file, along with the code to create the needed symbolic links. This consolidation simplifies the development and maintenance of the custom initialization.

The previous example would now initially look like this:

K34dhcrelay -> ../init.d/dhcrelay
K50netconsole -> ../init.d/netconsole
K80usermode-agent -> ../init.d/usermode-agent
K89rdisc -> ../init.d/rdisc
S01ovn makehooks -> /ovn/initscripts/ovn hook handler
S10network -> ../init.d/network
S12syslog-ng -> ../init.d/syslog-ng
S13portmap -> ../init.d/portmap
S25netfs -> ../init.d/netfs
S55sshd -> ../init.d/sshd
S56xinetd -> ../init.d/xinetd
S98dhcpd -> ../init.d/dhcpd
S99cracklibd -> ../init.d/cracklibd
S99local -> ../rc.local

Note the main symbolic link S10ovn_makehooks (underlined above) is now lexically first (or close to first) among the symbolic links to startup scripts. In addition, the contents of /etc/rc.d/rc.local would contain a line such as:
/ovn/initscripts/ovn_services start

After the first system startup the script /ovn/initscripts/ovn_hook_handler would delete any unneeded or obsolescent application-specific symbolic links, and then add the symbolic links appropriate for the given application load. The benefit of this approach is that the startup sequence can be customized for an application without having to modify the root filesystem via patches, which is what is the typical approach used in the prior art. After the first startup, the list would be as follows, with new and underlined “S[xx]ovn” symbolic links added as needed where [xx] is a two digit number.

After First Startup

K00ipmievd -> ../init.d/ipmievd
K20openais -> ../init.d/openais
K35dhcpd -> ../init.d/dhcpd
K35dhcrelay -> ../init.d/dhcrelay
K50netconsole -> ../init.d/netconsole
K70vblade -> ../init.d/vblade
K80usermode-agent -> ../init.d/usermode-agent
K84bgpd -> ../init.d/bgpd
K84ospf6d -> ../init.d/ospf6d
K84ospfd -> ../init.d/ospfd
K84ripd -> ../init.d/ripd
K84ripngd -> ../init.d/ripngd
K85zebra -> ../init.d/zebra
K89rdisc -> ../init.d/rdisc
K90network -> ../init.d/network
S10ovn_makehooks -> /ovn/initscripts/ovn_hook_handler
S11ovn_disable_logins -> /ovn/initscripts/ovn_hook_handler
S11ovn_program_ucd -> /ovn/initscripts/ovn_hook_handler
S11ovn_setmac -> /ovn/initscripts/ovn_hook_handler
S12syslog-ng -> ../init.d/syslog-ng
S13ipmi -> ../init.d/ipmi
S13iscsi -> ../init.d/iscsi
S13portmap -> ../init.d/portmap
S25netfs -> ../init.d/netfs
S25ocfs2.init -> ../init.d/ocfs2.init
S55sshd -> ../init.d/sshd
S56xinetd -> ../init.d/xinetd
S60ovn_init_zarlink -> /ovn/initscripts/ovn_hook_handler
S61ovn_program_fpga -> /ovn/initscripts/ovn_hook_handler
S62ovn_init_misc -> /ovn/initscripts/ovn_hook_handler
S63ovn_fs_patch -> /ovn/initscripts/ovn_hook_handler
S64ovn_dp_init -> /ovn/initscripts/ovn_hook_handler
S65ovn_pow_driver -> /ovn/initscripts/ovn_hook_handler
S66ovn_pcie_driver -> /ovn/initscripts/ovn_hook_handler
S66ovn_start_bridge -> /ovn/initscripts/ovn_hook_handler
S67ovn_mdio_driver -> /ovn/initscripts/ovn_hook_handler
S68ovn_8021q -> /ovn/initscripts/ovn_hook_handler
S69ovn_tipc -> /ovn/initscripts/ovn_hook_handler
S70ovn_db -> /ovn/initscripts/ovn_hook_handler
S71ovn_configboot -> /ovn/initscripts/ovn_hook_handler
S72ovn_config_server -> /ovn/initscripts/ovn_hook_handler
S73ovn_event_server -> /ovn/initscripts/ovn_hook_handler
S74ovn_snmpagent -> /ovn/initscripts/ovn_hook_handler
S76ovn_alarm_server -> /ovn/initscripts/ovn_hook_handler
S76ovn_pmserver -> /ovn/initscripts/ovn_hook_handler
S77ovn_cardmon_server -> /ovn/initscripts/ovn_hook_handler
S78ovn_hwmon -> /ovn/initscripts/ovn_hook_handler
S79ovn_dp_config_client -> /ovn/initscripts/ovn_hook_handler
S7iscsid -> ../init.d/iscsid
S80ovn_config_client -> /ovn/initscripts/ovn_hook_handler
S80ovn_eth_cnt_server -> /ovn/initscripts/ovn_hook_handler
S80ovn_ipf_config_client -> /ovn/initscripts/ovn_hook_handler
S81ovn_irq_hdlr -> /ovn/initscripts/ovn_hook_handler
S81ovn_irq_server -> /ovn/initscripts/ovn_hook_handler
S87boa -> ../init.d/boa
S95atd -> ../init.d/atd
S98ovn_last -> /ovn/initscripts/ovn_hook_handler
S99cracklibd -> ../init.d/cracklibd
S99local -> ../rc.local

Note that after the first start up in this example, all of the “Sxxovn” links point to the same file /ovn/initscripts/ovn_hook_handler. This script (ovn_hook_handler) can use the arg[0] concept to determine which startup link is calling the ovn_hook_handler and take the appropriate specific action. For example, when ovn_hook_handler is called by S10ovn_makehooks instead of S11ovn_disable_logins, the ovn_hook_handler knows which startup link called ovn_hook_handler and responds differently than when called by S11ovn_disable logins.

ASIDE—while it is preferred to have the ovn_hook_handler handle a number of scripts rather than maintaining a set of soft links to a series of independent scripts, this is not required in order to obtain benefits from the teachings of the current disclosure. Modifications to the init directory to have soft links to a series of script files rather than to a single global ovn_hook_handler would still have the benefit of avoiding subsequent patches to the init directory.

Optionally, you can force ovn_hook_handler to be executed first by picking a prefix that would be executed earlier than any traditional file provided by the factory. (i.e. S00aaaovn_hook_handler). Having the ovn_hook_handler executed first, simplifies rescan. In the example set forth above the call to ovn_hook_handler was the first start script as the call was made from S10ovn_makehooks . . . and Start “10 . . . ” would be before traditional script names.

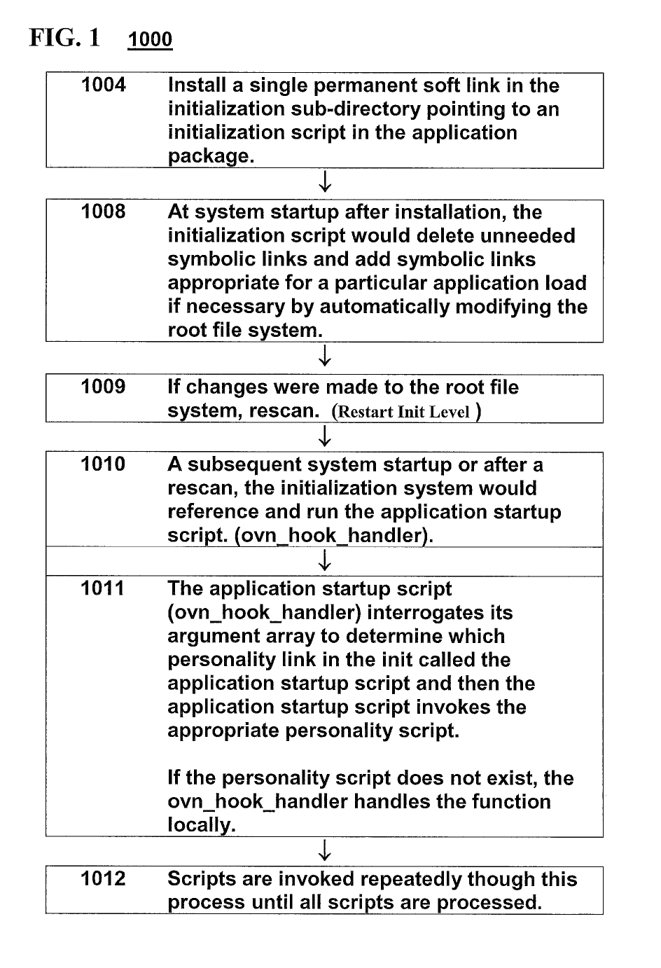

FIG. 1 provides a summary of one implementation of the teachings of the present disclosure.

1004—Install a single permanent soft link in the initialization sub-directory pointing to an initialization script in the application package. In the example provided above this was S10ovn_makehooks which pointed to /ovn/initscripts/ovn_hook_handler which is outside of the initialization sub-directory. Normally, this installed soft link would be set up to be executed early in the startup sequence.

1008—At system startup after installation, the initialization script in the application package would delete unneeded symbolic links and add symbolic links appropriate for a particular application load. If necessary the initialization script would modify the root file system.

1009—If changes were made to the root file system, then restart Init Level.

1010—A subsequent system startup or after a rescan, the initialization system would reference and run the application startup script. In this example—ovn_hook_handler.

1011—The application startup script (ovn_hook_handler) interrogates its argument array to determine which personality link in the init called the application startup script and then the application startup script invokes the appropriate personality script. If the personality script does not exist, the ovn_hook_handler handles the function locally. Thus, ovn_hook_handler may respond to a call from S11ovn_disable_logins by invoking a script relevant to S11ovn_disable_logins and different from the script invoked when ovn_hook_handler is called by S10ovn_makehooks.

1012—Scripts are invoked repeatedly through this process until all the scripts are processed.

Appendix A

Appendix A shows one implementation of a ovn_hook_handler script for use in a Linux system

In summary, the teachings of the present disclosure may be used to reduce the application-specific footprint in the root filesystem to a minimum, allowing simplified development and delivery of updated application software and any required updates to the initialization process.

Alternatives and Variations

The teachings set forth above may be used in other settings and situations. Non-limiting examples are set forth below.

Operating Systems

While the present disclosure has specifically named Linux and Unix, one of skill in the art will appreciate that the teachings of the present disclosure may be adapted for use in other operating systems that have an initialization sequence.

Other Uses Beyond Normal Startup

The description above was for runlevel 3 startup of applications. The same method can be used for shutdown as well as be applied to all init levels. Thus, while the example was for /etc/rc.d/rc3.d, the same process could be adapted for use in rc0.d, rc1.d, rc2.d, rc5.d, rc6.d, and any other directory with a sequence of scripts. Another application of the teachings of the present disclosure includes changing startup behavior based on a crash, restart or other unusual event.

The disclosed methods support the enforcement of coupling of startup routines with runtime routines. For example, consider a typical anti-virus program that needs to check for updates of its virus database. If the update checker was a stand-alone program, it would normally be put into the init script system in a different location than the actual anti-virus software. Using the teachings of the present disclosure to have the compiled anti-virus application software change the init sequence keeps the two pieces (checker and runtime) coupled in an atomic fashion from the perspective of the user. Doing so would eliminate any handle that the user would otherwise have to eliminate the check for database updates without eliminating the anti-virus software altogether.

In short, any process or mechanism related to system startup could potentially be improved by use of the teachings of the present disclosure. Doing so would provide a simpler, more efficient and smaller implementation than would be attainable using the prior art.

Computer Components

The teachings of the present disclosure may be used to modify the behavior of a computer system. In order to lay a foundation for claims that recite one or more components of a computer it can be useful to give a high level description of the components in a computer which is operating under control of software. The software must be stored on media and be accessible by a processor which executes the program. Certain programs running on the computer must be able to receive input from the user. Those programs must be able to act through the computer system to communicate to the user and to others receiving the input from the user.

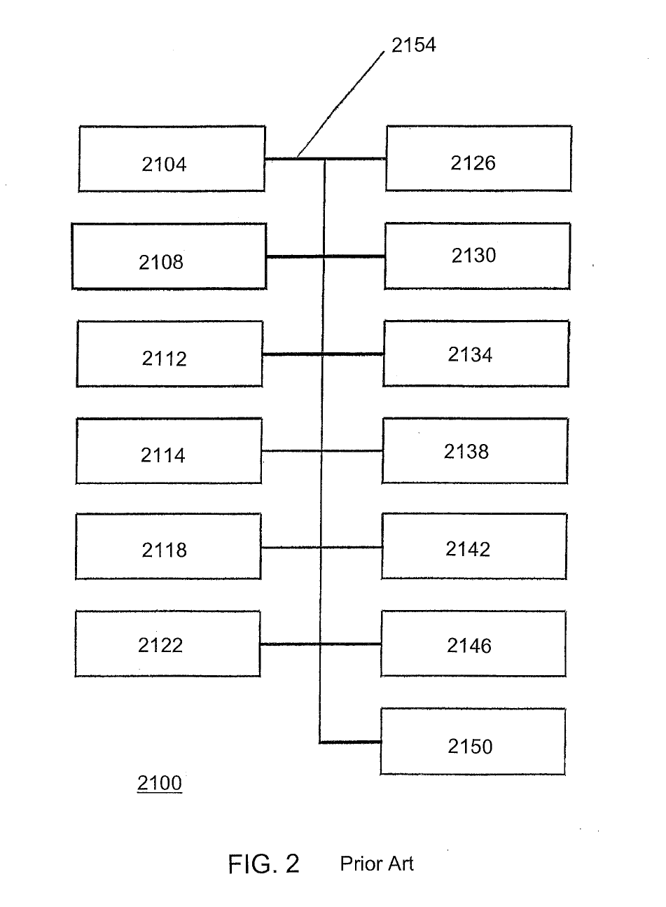

Computer systems 1100 known in the art can be represented generically by FIG. 2. Such a system will comprise a number of separate pieces but can be diagrammed as follows:

Element 2104 is an I/O Controller. An Input Output Controller works with the CPU for handling certain aspects of interactions with input/output devices.

Element 2108 is a DMA controller to allow direct communication between certain peripherals and RAM.

Element 2112 is the Central Processor Unit (CPU or Microprocessor). The CPU executes instructions and manipulates data.

Element 2114 is the Clock. The clock provides the one or more clock signals used by other components.

Element 2118 is the RAM (Random Access Memory) which is used for temporary memory when executing software.

Element 2122 is the ROM (Read Only Memory) which contains permanent memory such as start-up instructions for the CPU.

Element 2126 is a Mass Storage Device. Most computers have one or more mass storage devices such as hard drives that store programs and data.

Element 2130 is a Media Drive. Most computers have one or more media drives such as CD drives or disc drives which can read programs and data from removable media. Many of these drives can also write to removable media.

Element 2134 is a Display. Most computers have one or more displays for displaying text or graphics.

Element 2138 is an Input Device. Most computers have one or more input devices such as keyboards, computer mouse, touch pad, touch screen, light pen, digitizer tablet, or joy stick. Most computers have more than one input device such as a keyboard and a mouse.

Element 2142 is a Network Connection. Many computers have one or more network connections. These connections come in a variety of types. For personal computers, the network connection may include a specialized card such as a NIC card (network interface card), or a wireless card to enable a particular type of wireless connection such as Bluetooth or one of the versions of 802.11.

Element 2146 is a Printer. Most computers have some access to a printer or other output device that produces output on paper. These include printers, plotters, and bar code printers. Some computers access printers through the network connection.

Element 2150 is a Speaker. Most computers have one or more speakers to provide audio feedback, music, sound effects, and voice.

Element 2154 represents the buses. The various components in the computer are connected by a set of buses that carry data, control signals, and addresses. As the subject matter of this disclosure does not involve an improvement to computer buses, the buses are shown in an over simplified manner to avoid unnecessary clutter.

Those of ordinary skill in the art will recognize that FIG. 2 does not capture all of the subcomponents necessary to operate a computer (no power supply for example). FIG. 2 does not show all possible variations of computers as certain elements can be combined together such as combining the clock and the CPU. Further, a computer may have more elements than are shown in FIG. 2 including multiple instances of components shown in FIG. 2 and additional elements not shown in FIG. 2. Finally a computer can be configured to be lacking one or more elements shown in FIG. 2. For example a computer can be configured to operate without a DMA controller, or some elements of the computer of FIG. 2 can be removed from the computer, especially if it has access to such components through a network connection.

It will be understood, and is appreciated by persons skilled in the art, that one or more processes, sub-processes, or process steps described in connection with the present disclosure may be performed by a combination of hardware and software. The software may reside in software memory internal or external to the processing unit in a suitable electronic processing component or system such as one or more of the functional components or modules. The software in memory may include an ordered listing of executable instructions for implementing logical functions (that is, “logic” that may be implemented either in digital form such as digital circuitry or source code or in analog form such as analog circuitry), and may selectively be embodied in any tangible computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any means that may contain, store, communicate, propagate, or transport the program for use by or in connection with the instruction execution system, apparatus, or device. The computer readable medium may selectively be, for example, but is not limited to, an electronic, magnetic, optical, electromagnetic, infrared, or semiconductor system, apparatus, device, or medium. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic), and a portable compact disc read-only memory “CDROM” (optical) or similar discs (e.g., DVDs and Rewritable CDs). Note that the computer-readable medium may even be paper or another suitable medium upon which the program is printed, as the program can be electronically captured, via, for instance, optical scanning or reading of the paper or other medium, then compiled, interpreted or otherwise processed in a suitable manner if necessary, and then stored in the memory.

Distribution of Software.

It is also important to note that although the present disclosure has been described in the context of a fully functional computer system, those skilled in the art will appreciate that the mechanisms of the present disclosure are capable of being distributed as a program product or a portion of a suite of programs. This distribution may be done in a variety of forms. The inventiveness of the present disclosure is present in a set of computer instructions adapted to implement some or all of the innovations described above regardless of how this set of instructions is conveyed. A set of computer instructions is a set of instructions adapted for use by a computer in achieving some or all of the advantages set forth above and is distinguishable from a paper such as this disclosure that describes the attributes of an implementation without providing anything that can be processed by computer components available in 2010 to ultimately be executed by a computer.

One of skill in the art will recognized that the set of computer instructions may be stored on one or more mass storage memory devices that are accessible by a particular computer system to implement some or all of the innovations described above. The set of computer instructions may be conveyed in one of many types of signal bearing media. Signal bearing media carrying instructions to be executed by one or more computer programming languages may be conveyed in different formats including without limitation program instructions in high level programming languages or in machine code. The signal bearing media may be located on traditional articles of manufacture that are any one of a variety of recordable type media such as floppy disks or compact discs (including write once and re-recordable media). In this instance the recordable type media receives a written set of computer instructions which can subsequently be read by an input device. The recordable type media may then be shipped from one place to another such as shipped to a customer and then the customer may access the computer instructions written into the recordable type media.

A separate category of signal bearing media not currently considered a traditional article of manufacture under the United States patent laws is a paper printout carrying the sequence of computer instructions in at least one computer software language. One of skill in the art will recognized that an appropriate scanner may read paper through such routes as bar code readers, optical character recognition (OCR) of text, or via detection of holes in paper cards or paper tape.

The signal bearing media may be any of the many transmission type media such as analog or digital communications links as the software may be conveyed to a purchaser without the shipment of permanent tangible media but through a transitory propagating signal such as a series of internet protocol packets.

To the extent that the relevant patent laws allow issuance of claims covering each of these three types of signal bearing media, (recordable media, paper printout, and transmission type media), then it is the intent to include such signal bearing media within the scope of relevant claims.

One of skill in the art will recognize that some of the alternative implementations set forth above are not universally mutually exclusive and that in some cases additional implementations can be created that employ aspects of two or more of the variations described above. Likewise, the present disclosure is not limited to the specific examples or particular embodiments provided to promote understanding of the various teachings of the present disclosure. Moreover, the scope of the claims which follow covers the range of variations, modifications, and substitutes for the components described herein as would be known to those of skill in the art.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

1. A method for modifying a startup sequence for a computer system using a directory-based initialization process comprising:
installing in a memory device accessible to a computer system a permanent soft-link in an initialization directory, the permanent soft-link pointing to an initialization script located outside of the initialization directory;
initiating a system startup of the computer system wherein the initialization script acts to modify the startup sequence to include execution of an application script; and
initiating a subsequent system startup wherein the application script is executed.

2. The method of claim 1 wherein the initialization script is executed during system startup and during system shutdown.

3. The method of claim 1 wherein the initialization script acts to modify the shutdown sequence by adding at least one symbolic link to the initialization directory.

4. The method of claim 1 wherein the permanent soft-link in the initialization directory is named so that the permanent soft-link is a start script executed early in the startup sequence for a particular initialization so as to alter the startup sequence as it continues in that particular initialization after a first execution of the initialization script as well as subsequent system startups.

5. The method of claim 4 wherein the permanent soft-link is the first start script executed in the startup sequence.

6. The method of claim 1 wherein execution of the initialization script causes permanent changes that are applied to subsequent system startups.

7. The method of claim 1 wherein execution of the initialization script causes permanent changes that are applied to subsequent system shutdowns.

8. The method of claim 1 further comprising:
installing in a memory device accessible to a computer system the permanent soft-link in the initialization directory so as to allow execution of the permanent soft-link during a smooth shutdown, the permanent soft-link pointing to the initialization script located outside of the initialization directory;
initiating a smooth shutdown of the computer system wherein the initialization script acts to modify the startup and shutdown sequence to include execution of at least one application script; and
initiating a subsequent system startup wherein the at least one application script is executed.

9. The method of claim 1 wherein the initialization script acts to modify the startup sequence by adding at least one symbolic link to the initialization directory.

10. The method of claim 1 wherein the initialization script acts to modify the startup sequence by deleting unneeded symbolic links and adding symbolic links to the initialization directory.

11. The method of claim 1 wherein during the initiated subsequent system startup,
the modified startup sequence invokes the application script with a first personality link, and the application script responds by initiating a first application script relevant to the first personality link; and
the modified startup sequence invokes the application script with a second personality link after the invocation by the first personality link; and the application script responds by initiating a second application script relevant to the second personality link and different from the first application script.

12. The method of claim 1 wherein during the initiated subsequent system startup,
the modified startup sequence invokes a first soft-link, which invokes a first application script; and
the modified startup sequence invokes a second soft-link which invokes a second application script different from the first application script.

13. The method of claim 1 wherein the directory-based initialization process is a Linux based system.

14. A computer system configured with an operating system adapted to initiate a startup sequence for the computer system through a use of scripts in various initialization directories, the computer system comprising:
a set of at least one memory device accessible to a computer system containing:
an initialization directory, the initialization directory containing:
a permanent soft-link in an initialization directory pointing to an initialization script located outside of the initialization directory;
a first personality link which initiates operation of the initialization script; and
a second personality link which initiates operation of the initiation script;
the initialization script which
responds to initiation from the first personality link by initiating execution of a first application script and
responds to the initiation from the second personality link by initiating execution of a second application script different from the first application script.

15. Computer-readable medium containing computer-executable instructions configured to:
cause a computer system to modify an initialization directory to point to an initialization script located outside of the initialization directory; and
install the initialization script outside of the initialization directory, the initialization script adapted to modify a startup sequence for the computer system.

16. The computer-readable medium of claim 15 wherein the initialization script when executed modifies the initialization directory such that a first start script in the initialization directory initiates the initialization script which responds by initiating a first application script, and the initialization directory contains a second start script that initiates the initialization script which responds by initiating a second application script different from the first application script.
